(19) United States
(12) Patent Application Publication
(10) Pub. No.: US 2011/0216639 A1
(43) Pub. Date: Sep. 8, 2011

(54) DETECTOR AND DETECTION METHOD

(75) Inventors: Yasuhiko TOMIKAWA, Kyoto (JP); Mayumi Yasukouchi, Osaka (JP); Teruhiko Izumi, Osaka (JP); Tsuyoshi Hiraki, Osaka (JP)

(73) Assignee: PANASONIC CORPORATION, Osaka (JP)

(21) Appl. No.: 13/106,653

(22) Filed: May 12, 2011

Related U.S. Application Data
(63) Continuation of application No. PCT/JP2009/006130, filed on Nov. 16, 2009.

(30) Foreign Application Priority Data
Nov. 14, 2008 (JP) 2008-292578
Jun. 15, 2009 (JP) 2009-141966

(51) Int. Cl. G11B 7/00

(52) U.S. Cl. 369/53.31; G9B/7

(57) ABSTRACT

The present disclosure improves tracking characteristics of an envelope detected from an input signal to the input signal. A detector, which obtains an output signal from an input signal containing a target signal, and outputs the output signal, includes: a comparator configured to compare the input signal to the output signal, and output an obtained comparison result; and an envelope generator configured to weight a first value and a second value having a sign opposite to that of the first value in accordance with the comparison result, integrate the weighted first value and the weighted second value, and output an integral value as the output signal. The envelope generator includes a first gain generator configured to output the first value in accordance with an amplitude of the input signal.

### CROSS-REFERENCE TO RELATED APPLICATION

This is a continuation of PCT International Application PCT/JP2009/006130 filed on Nov. 16, 2009, which claims priority to Japanese Patent Application No. 2008-292578 filed on Nov. 14, 2008, and Japanese Patent Application No. 2009-141966 filed on Jun. 15, 2009. The disclosures of these applications including the specifications, the drawings, and the claims are hereby incorporated by reference in their entirety.

### BACKGROUND

The present disclosure relates to detectors detecting envelopes of input signals.

Optical disk reproducing devices detect envelops of radio frequency (RF) signals read out from optical disks using optical pickups, and generate peak signals tracking maximum values of the RF signals and bottom signals tracking minimum values of the RF signals. For example, Japanese Patent Application No. 2001-167440 shows a signal amplitude measurement circuit with a circuit size reduced by utilizing the feature that an RF signal is a pseudo random signal. In this circuit, an analog-to-digital (AD) converter with a low conversion rate is used, and a part of values obtained by AD conversion at several times is regarded as a peak level or a bottom level.

### SUMMARY

Since RF signals are analog signals, a converter is needed to perform conversion between analog signals and digital signals to form a detector performing envelope detection of RF signals using a digital circuit. Since some conversion time is required when performing conversion with the converter, a peak signal or a bottom signal detected as an envelope may not completely track a change of the RF signal.

It is an objective of the present disclosure to improve tracking characteristics of an envelope detected from an input signal to the input signal.

A detector according to an example embodiment of the present disclosure obtains an output signal from an input signal containing a target signal, and outputs the output signal. The detector includes a comparator configured to compare the input signal to the output signal, and output an obtained comparison result; and an envelope generator configured to weight a first value and a second value having a sign opposite to that of the first value in accordance with the comparison result, integrate the weighted first value and the weighted second value, and output an integral value as the output signal. The envelope generator includes a first gain generator configured to output the first value in accordance with an amplitude of the input signal.

According to this feature, the first value or the second value is integrated in accordance with the amplitude of the input signal. This appropriately changes tracking characteristics of the integral value to the input signal so that the detector can stably operate.

A detection method according to an example embodiment of the present disclosure obtains an output signal from an input signal containing a target signal. The method comprising: comparing the input signal to the output signal; weighting a first value and a second value having a sign opposite to that of the first value in accordance with an obtained comparison result, integrating the weighted first value and the weighted second value, and outputting an integral value as the output signal; detecting from the input signal, an unnecessary frequency component which is a frequency component other than a frequency component of the target signal; and mitigating an increase in an absolute value of the integral value when the unnecessary frequency component has been detected.

According to the example embodiments of the present disclosure, tracking characteristics of an envelope (a peak signal or a bottom signal) detected from an input signal to the input signal can be changed in accordance with the input signal, thereby enabling appropriate envelope detection according to conditions.

### BRIEF DESCRIPTION OF THE DRAWINGS

FIG. 1 is a block diagram illustrating a configuration of an envelope detection circuit according to an embodiment of the present disclosure.

FIG. 2 is a graph illustrating examples of an RF signal, a peak signal, and a bottom signal.

FIG. 3 is a graph illustrating examples of an RF signal, a peak signal, and an output of a comparator in a time period in which the RF signal is stable.

FIG. 4 is a graph illustrating examples of an RF signal, a peak signal, and an output of the comparator in a time period in which the RF signal drops out.

FIG. 5 is a graph illustrating examples of an RF signal, a peak signal, and an output of the comparator in a time period in which the RF signal suddenly drops.

FIG. 6 is a block diagram illustrating a configuration of a part for peak detection in an envelope detection circuit according to a first variation of the present disclosure.

FIG. 7 is a circuit diagram of a detection circuit included in an integration controller of FIG. 6.

FIG. 8 is a block diagram illustrating a configuration of a peak detection circuit according to a second variation of the present disclosure.

### DETAILED DESCRIPTION

Embodiments of the present disclosure will be described hereinafter with reference to the drawings. Elements indicated by reference characters with the same last two digits in the drawings correspond to each other, and are the same or similar elements. In the drawings, solid lines between functional blocks represent electrical coupling.

The functional blocks in the specification can be typically realized as hardware. For example, the functional blocks can be formed on a semiconductor substrate as a part of an integrated circuit (IC). The IC includes a large-scale integrated circuit (LSI), an application-specific integrated circuit (ASIC), a gate array, a field programmable gate array (FPGA), etc. As an alternative, a part of or all of the functional blocks are realized as software. For example, such functional blocks are realized by a program executed in a processor. In other words, the functional blocks described in the specification may be realized as hardware, software, or a preferable combination of hardware and software.

### Embodiment

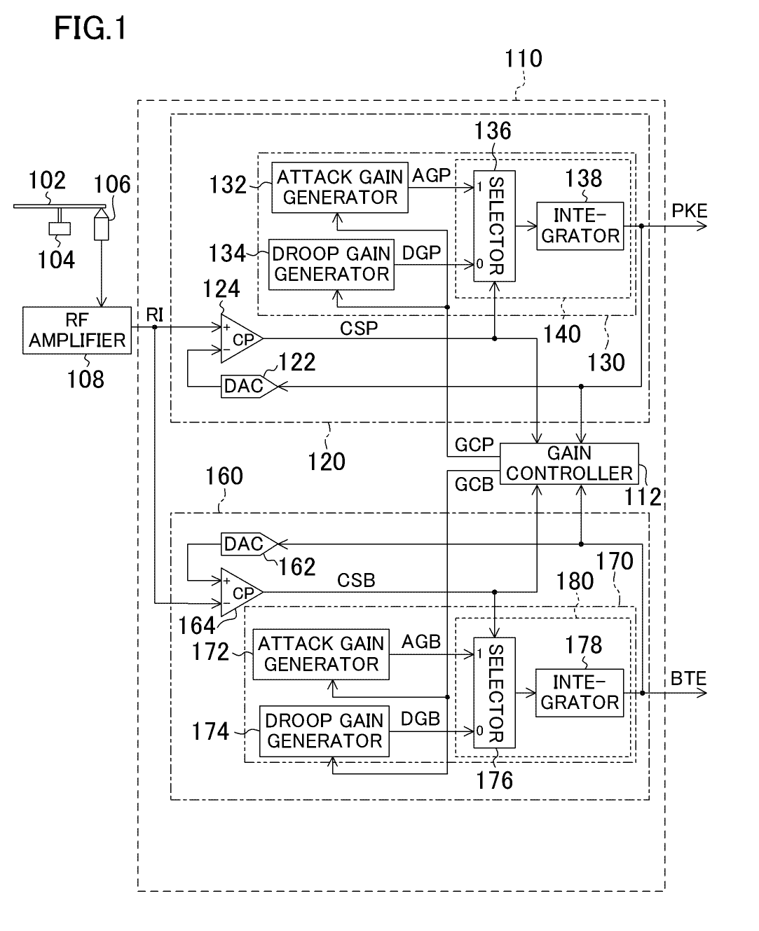

FIG. 1 is a block diagram illustrating a configuration of an envelope detection circuit 110 according to an embodiment of the present disclosure. The envelope detection circuit (detector) 110 of FIG. 1 detects an envelope of a radio frequency (RF) signal RI read out from an optical disk 102, and outputs the detected envelope as a peak signal PKE and a bottom signal BTE.

A spindle motor 104 rotates the optical disk 102. An optical pickup 106 reads a signal recorded on the optical disk 102, and outputs the signal corresponding to a signal recorded on the optical disk 102 to an RF amplifier 108. The RF amplifier 108 amplifies the signal received from the optical pickup 106, and outputs the signal to the envelope detection circuit 110 as the RF signal M. The RF signal RI, which is an input signal of the envelope detection circuit 110, is influenced by a scratch or a fingerprint on the optical disk, black dropout (dropout of a read-out signal caused by dust etc. on the disk), and exfoliation of a recording layer, etc. When reading a recordable optical disk, an amplitude of the RF signal RI differs depending on whether or not a region has already been used for recording. In general, an RF signal RI contains a “target signal” from which the envelope is to be extracted by detection, and “noise” having a frequency component other than a frequency component of the target signal.

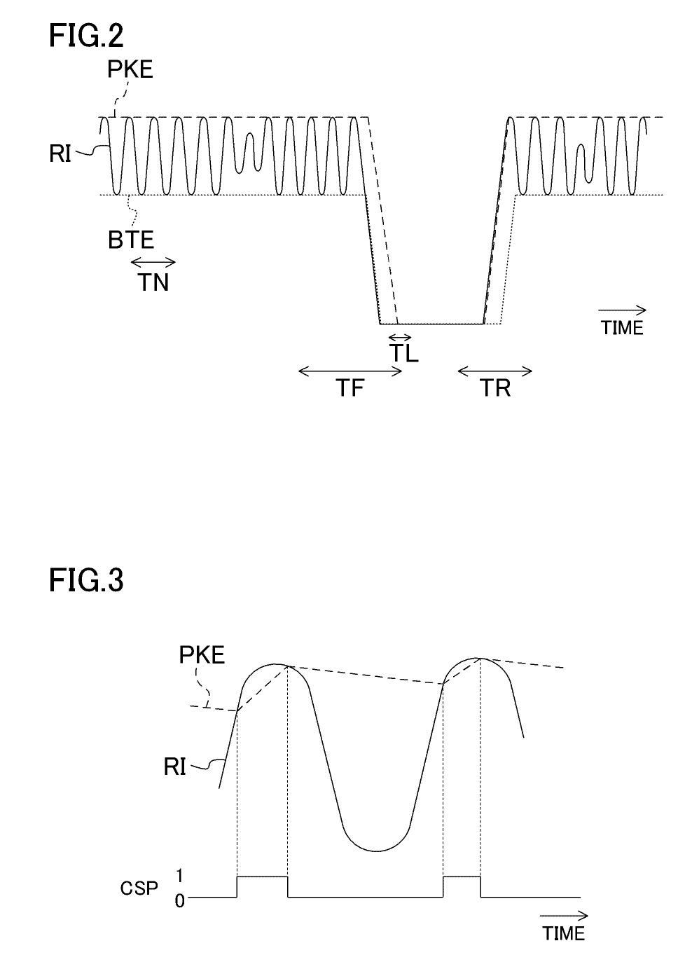

FIG. 2 is a graph illustrating examples of the RF signal RI, the peak signal PKE, and the bottom signal BTE. A difference between the peak signal PKE and the bottom signal BTE roughly represents the amplitude of the RF signal RI. FIG. 3 is a graph illustrating examples of the RF signal RI, the peak signal PKE, and an output CSP of the comparator in a time period (i.e., a time period TN in FIG. 2) in which the RF signal RI is stable. In the specification, an envelope is a line such as the peak signal PKE or the bottom signal BTE of FIG. 2, which connects peaks or bottoms of a signal as a whole. For example, the envelope of the RF signal RI includes a waveform of the peak signal PKE including a time period in which the value of the peak signal PKE temporarily falls below the value of the RF signal RI as shown in FIG. 3.

The envelope detection circuit 110 of FIG. 1 includes a gain controller 112, a peak detection circuit 120, and a bottom detection circuit 160. The peak detection circuit 120 includes a digital-to-analog (DA) converter (hereinafter referred to as a “DAC”) 122, a comparator 124, and an envelope generator 130. The envelope generator 130 includes an attack gain generator 132, a droop gain generator 134, and a computing section 140. The computing section 140 includes a selector 136 and an integrator 138. The bottom detection circuit 160 includes a DAC 162, a comparator 164, and an envelope generator 170. The envelope generator 170 includes an attack gain generator 172, a droop gain generator 174, and a computing section 180. The computing section 180 includes a selector 176 and an integrator 178.

The DAC 122 converts the input peak signal PKE (an integral value of the integrator 138) to an analog signal, and output the analog signal to the comparator 124. The comparator 124 compares the RF signal RI to an output of the DAC 122, and outputs to the selector 136, “1” when the RF signal RI is greater than the output of the DAC 122, and “0” when the RF signal RI is equal to or less than the output of the DAC 122, as a comparison result CSP (see FIG. 3).

The attack gain generator 132 outputs to the selector 136, a value corresponding to a gain control signal GCP output from the gain controller 112 as an attack gain AGP. The droop gain generator 134 outputs to the selector 136, a value corresponding to the gain control signal GCP output from the gain controller 112 as a droop gain DGP. The attack gain AGP is a predetermined positive value, and the droop gain DGP is a predetermined negative value. The absolute value of the attack gain AGP is greater than the absolute value of the droop gain DGP. For example, the value of the attack gain AGP is 100, and the value of the droop gain DGP is −1. The absolute values may be 1 or less. For example, the value of the attack gain AGP may be 1, and the value of the droop gain DGP may be −0.01.

The selector 136 selects the attack gain AGP when the comparison result CSP is “1,” and the droop gain DGP when the comparison result CSP is “0;” and outputs the selected gain value to the integrator 138. The integrator 138 integrates an input value from the selector 136, and outputs the obtained integral value to the DAC 122 and outside the envelope detection circuit 110 as the peak signal PKE.

The selector 136 may have a calculation function, weight the attack gain AGP and the droop gain DGP (i.e., multiplies the gains by respective weights) in accordance with the value of the comparison result CSP, and output a sum of the weighted attack gain AGP and the weighted droop gain DGP to the integrator 138. Assume that a first case is where the comparison result CSP is “1,” and a second case is where the comparison result CSP is “0.”

Specifically, in the first case, the selector 136 sets the weight of the attack gain AGP to be equal to or greater than that in the second case, and the weight of the droop gain DGP to be equal to or less than that in the second case. In the second case, the selector 136 sets the weight of the droop gain DGP to be equal to or greater than that in the first case, and the weight of the attack gain AGP to be equal to or less than that in the first case. Note that at least one of the weight of the attack gain AGP or the weight of the droop gain DGP has different values in the first case and in the second case. The integrator 138 integrates the weighted attack gain and the weighted droop gain. This is applicable to the following description.

Note that the weight corresponding to either one of the attack gain AGP or the droop gain DGP may be 0, based on the value of the comparison result CSP. In this case, this corresponds to the case where the selector 136 performs selection without weighting as described above.

As such, the DAC 122, the comparator 124, the selector 136, and the integrator 138 form a feedback loop. As shown in FIGS. 2 and 3, the peak signal PKE is almost identical to an envelope connecting peak values of the RF signal M.

The DAC 162 converts the input bottom signal BTE (the integral value of the integrator 178) to an analog signal, and outputs the analog signal to the comparator 164. The comparator 164 compares the RF signal RI to an output of the DAC 162, and outputs to the selector 136, “1” when the RF signal RI is smaller than the output of the DAC 162, and “0” when the RF signal RI is equal to or more than the output of the DAC 162, as comparison result CSB.

The attack gain generator 172 outputs to the selector 176, a value corresponding to a gain control signal GCB output from the gain controller 112 as an attack gain AGB. The droop gain generator 174 outputs to the selector 176, a value corresponding to a gain control signal GCB output from the gain controller 112 as a droop gain DGB. The attack gain AGB is a predetermined negative value, and the droop gain DGB is a predetermined positive value. The absolute value of the attack gain AGB is greater than the absolute value of the droop gain DGB. For example, the value of the attack gain AGB is −100, and the value of the droop gain DGB is 1. These absolute values may be 1 or less. For example, the value of the attack gain AGP may be −1, and the value of the droop gain DGP may be 0.01.

The selector 176 selects the attack gain AGB when the comparison result CSB is “1,” and the droop gain DGB when the comparison result CSB is “0;” and outputs the selected gain value to the integrator 178. The integrator 178 integrates an input value from the selector 176, and outputs the obtained integral value to the DAC 162 and outside the envelope detection circuit 110, as the bottom signal BTE.

The selector 176 may have a calculation function, weight the attack gain AGP and the droop gain DGP in accordance with the value of the comparison result CSB, and output a sum of the weighted attack gain AGB and the weighted droop gain DGB to the integrator 178. Assume that a third case is where the comparison result CSB is “1,” and a fourth case is where the comparison result CSB is “0.”

Specifically, in the third case, the selector 176 sets the weight of the attack gain AGB to be equal to or greater than that in the fourth case, and the weight of the droop gain DGB to be equal to or less than that in the fourth case. In the fourth case, the selector 176 sets the weight of the droop gain DGB to be equal to or greater than that in the third case, and the weight of the attack gain AGB to be equal to or less than that in the third case. Note that at least one of the weight of the attack gain AGB or the weight of the droop gain DGB has different values in the third case and in the fourth case. The integrator 178 integrates the weighted attack gain and the weighted droop gain.

Note that the weight of either one of the attack gain AGB or the droop gain DGB may be 0 in accordance with the value of the comparison result CSB. This corresponds to the case where the selector 176 performs selection without weighing as described above.

As such, the DAC 162, the comparator 164, the selector 176, and the integrator 178 form a feedback loop. As shown in FIG. 2, the bottom signal BTE is almost identical to an envelope connecting bottom values of the RF signal M. In the case of FIG. 3, the values of the attack gains AGP and AGB, and the droop gains DGP and DGB are constant.

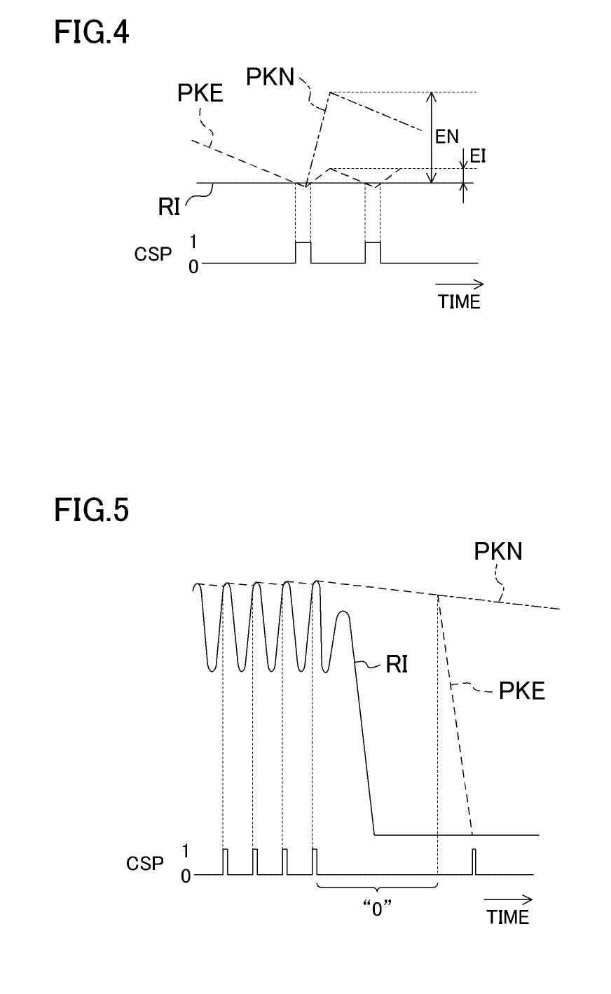

FIG. 4 is a graph illustrating examples of the RF signal RI, the peak signal PKE, and the output CSP of the comparator in a time period (i.e., a time period TL in FIG. 2) in which the RF signal RI drops out. The peak signal PKE in the time period TL, in which the level of the RF signal RI is almost 0 due to black dropout etc., will be described with reference to FIG. 4.

When the peak signal PKE gradually decreases and falls below the level of the RF signal RI, the comparison result CSP of the comparator 124 becomes “1.” Then, the selector 136 selects the attack gain AGP. Since the value of the attack gain AGP is relatively great and is influenced by delay of a response from the DAC 122, the peak signal PKE has a higher level than the RF signal RI by EN as indicated by a line PKN. However, a level difference between the peak signal PKE and the RF signal RI is preferably small.

Thus, the gain controller 112 obtains the difference between the peak signal PKE and the bottom signal BTE. The difference can be regarded as the amplitude of the RF signal RI. The gain controller 112 outputs the gain control signal GCP corresponding to this amplitude. For example, when the amplitude is smaller than a threshold value, the gain controller 112 outputs the gain control signal GCP instructing to reduce the absolute value of the attack gain AGP. In the time period TL of FIG. 2, the amplitude of the RF signal RI obtained from the difference between the peak signal PKE and the bottom signal BTE is almost 0. Thus, if the amplitude is smaller than the threshold value, the attack gain generator 132 reduces the absolute value of the attack gain AGP in accordance with the gain control signal GCP.

Once the peak signal PKE falls below the level of the RF signal RI, the level of the peak signal PKE rises from the RF signal RI only by EI (see FIG. 4). That is, an increase in the level difference between the peak signal PKE and the RF signal RI can be mitigated.

Furthermore, when the attack gain generator 132 reduces the value of the attack gain AGP, the droop gain generator 134 may reduce the absolute value of the droop gain DGP in accordance with the gain control signal GCP. At this time, the droop gain generator 134 may change the droop gain DGP so that a ratio of the droop gain DGP to the attack gain AGP is constant.

When the amplitude of the RF signal RI is equal to or greater than the threshold value, the gain controller 112 outputs the gain control signal GCP instructing to reset the gain. The attack gain generator 132 and the droop gain generator 134 reset the values of the attack gain AGP and the droop gain DGP in accordance with the gain control signal GCP.

While the peak detection circuit 120 has been described above, the bottom detection circuit 160 in a time period in which the RF signal RI holds a high value can be similarly described.

As such, according to the envelope detection circuit 110 of FIG. 1, tracking characteristics of the peak signal PKE and the bottom signal BTE to the RF signal can be changed in accordance with the amplitude of the RF signal RI, thereby enabling stable detection.

While an example has been described where the attack gain generator 132 and the droop gain generator 134 change the attack gain AGP and the droop gain DGP at the same time, the change may not be made at the same time.

While the difference between the peak signal PKE and the bottom signal BTE is used as the amplitude of the RF signal RI, the amplitude of the RF signal RI may be obtained based on other signals. A different threshold value may be used in accordance with use and conditions.

FIG. 5 is a graph illustrating examples of the RF signal RI, the peak signal PKE, and the output CSP of the comparator in a time period (i.e., a time period TF in FIG. 2) in which the RF signal RI suddenly drops. When black dropout occurs, the RF signal RI suddenly drops as shown in FIG. 5. In this case, if the droop gain DGP is constant, the peak signal gradually decreases as indicated by a line PKN, thereby deteriorating the tracking characteristics of the peak signal to the RF signal RI. Thus, the gain controller 112 determines whether or not the RF signal RI is spaced apart from the peak signal PKE by a predetermined reference value or more, and outputs the gain control signal GCP instructing to increase the absolute value of the droop gain DGP when the gain controller 112 has determined that the RF signal RI is spaced apart from the peak signal PKE by the predetermined reference value or more.

In the time period in which the RF signal RI is stable as shown in FIG. 3, the comparison result CSP of the comparator 124 becomes “1” in each period of the RF signal RI. However, when the RF signal RI suddenly drops, the RF signal RI is not larger than the peak signal PKE, and thus, the state in which the comparison result CSP of the comparator 124 is “0” is continued. Therefore, the gain controller 112 determines whether or not the RF signal RI is spaced apart from the peak signal PKE by the predetermined reference value or more based on whether or not the state in which the comparison result CSP of the comparator 124 is “0” is continued for a predetermined number of periods of the RF signal RI.

When the state in which the comparison result CSP is “0” is continued for the predetermined number of periods, the gain controller 112 outputs the gain control signal GCP instructing to increase the absolute value of the droop gain DGP. The droop gain generator 134 increases the absolute value of the droop gain DGP in accordance with the gain control signal GCP. Then, the peak signal PKE suddenly drops, thereby improving tracking characteristics of the peak signal PKE to the RF signal RI (see FIG. 5).

As an alternative, the gain controller 112 may determine whether or not the RF signal RI is spaced apart from the peak signal PKE by the predetermined reference value or more based on whether or not the difference between the RF signal RI (an output of the RF amplifier 108) and the peak signal PKE is equal to or greater than a threshold value.

The peak detection circuit 120 has been described with reference to FIG. 5. Next, the bottom detection circuit 160 will be described. In the time period TR (see FIG. 2) in which the RF signal RI suddenly rises after the sudden drop, the gain controller 112 performs control of the bottom detection circuit 160, similar to the peak detection circuit 120.

The gain controller 112 determines whether or not the RF signal RI is spaced apart from the bottom signal BTE by a predetermined reference value or more, and outputs the gain control signal GCB instructing to increase the absolute value of the droop gain DGB when the gain controller 112 has determined that the RF signal RI is spaced apart from the bottom signal BTE by the predetermined reference value or more. Specifically, the gain controller 112 determines whether or not the RF signal RI is spaced apart from the bottom signal BTE by the predetermined reference value or more based on whether or not the state in which the comparison result CSB of the comparator 164 is “0” (i.e., in which the RF signal RI is not smaller than the bottom signal BTE) is continued for a predetermined number of periods of the RF signal RI.

When the state “0” is continued for the predetermined number of periods, the gain controller 112 outputs the gain control signal GCB instructing to increase the absolute value of the droop gain DGB. The droop gain generator 174 increases the absolute value of the droop gain DGB in accordance with the gain control signal GCB. Then, the bottom signal BTE suddenly rises, thereby improving tracking characteristics of the bottom signal BTE to the RF signal RI.

As an alternative, the gain controller 112 may determine whether or not the RF signal RI is spaced apart from the bottom signal BTE by the predetermined reference value or more, based on whether or not the difference between the RF signal RI and the bottom signal BTE is equal to or greater than a threshold value.

As such, the gain controller 112 increases the absolute value of the droop gain DGP when the RF signal RI is greatly spaced apart from the peak signal PKE, and increases the absolute value of the droop gain DGB when the RF signal RI is greatly spaced apart from the bottom signal BTE. This improves tracking characteristics of the peak signal PKE and the bottom signal BTE to the RF signal RI.

According to the envelope detection circuit 110 of FIG. 1, the feedback loop may be easily formed by a digital circuit. Since the digital circuit does not require a high-speed AD converter for AD converting the RF signal RI, power consumption of the circuit can be reduced. In an envelope detection circuit formed by an analog circuit has the problem of variations in elements performing integration. The envelope detection circuit 110 is not influenced by the variations. In accordance with the conditions of the RF signal, tuning for improving noise resistance and tracking characteristics can be easily performed.

### First Variation

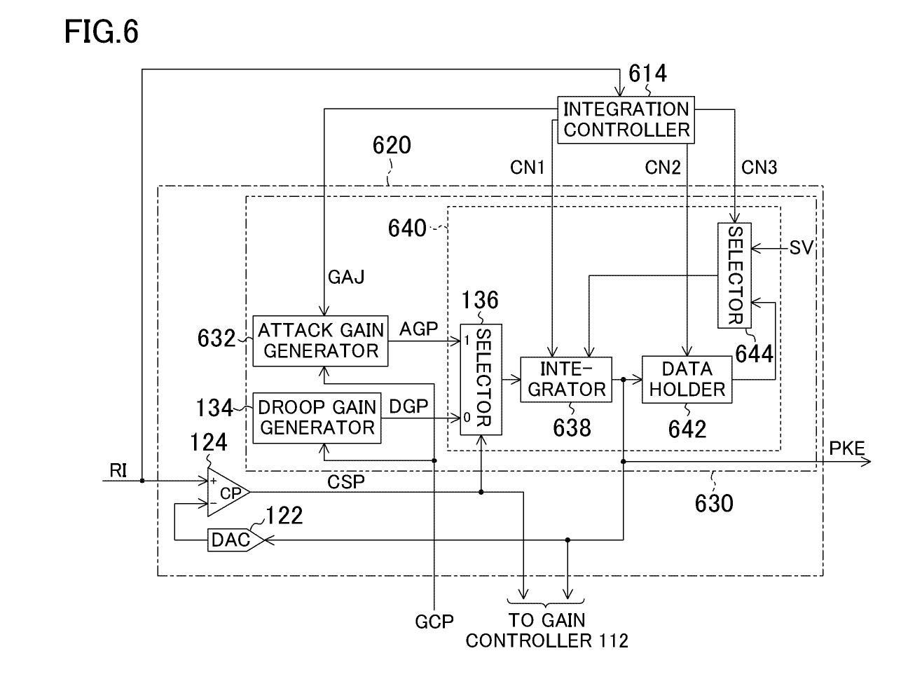

FIG. 6 is a block diagram illustrating a configuration of a part for peak detection of the envelope detection circuit according to a first variation of the present disclosure. The circuit of FIG. 6 includes a gain controller 112, an integration controller 614, a peak detection circuit 620, and a bottom detection circuit 160. The peak detection circuit 620 of FIG. 6 differs from the peak detection circuit 120 of FIG. 1 in that it includes a computing section 640 in place of the computing section 140. The peak detection circuit 620 includes an attack gain generator 632, a droop gain generator 134, a computing section 640, and an envelope generator 630. The computing section 640 includes selectors 136 and 644, an integrator 638, and a data holder 642.

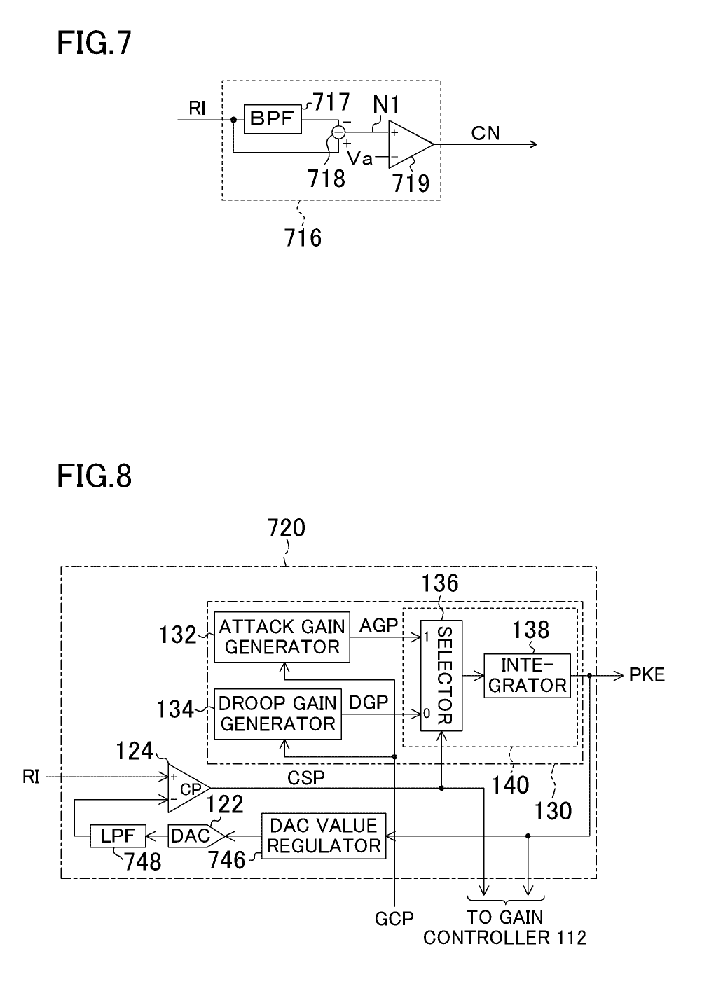

FIG. 7 is a circuit diagram of a detection circuit 716 included in the integration controller 614 of FIG. 6. The detection circuit 716 detects a frequency component other than a frequency component of a target signal from the RF signal RI (hereinafter referred to as an “unnecessary frequency component”). When the detection circuit 716 has determined that the RF signal RI substantially contains an unnecessary frequency component, the detection circuit 716 outputs a high (H) level signal as a control signal CN. On the other hand, when the detection circuit 716 has determined that the RF signal RI does not substantially contain any unnecessary frequency component, the detection circuit 716 outputs a low (L) level signal as the control signal CN.

More specifically, the detection circuit 716 includes a band-pass filter (BPF) 717, a subtractor 718, and a comparator 719. The BPF 717 allows a frequency component close to the center frequency of the BPF 717 to pass. The center frequency of the BPF 717 is a frequency of a main frequency component of the target signal contained in the RF signal RI. Therefore, the BPF 717 mainly outputs the target signal.

The subtractor 718 mainly outputs noise contained in the RF signal RI by subtracting the output signal (i.e., target signal) of the BPF 717 from the RF signal RI. The comparator 719 compares the noise to a reference voltage Va. The output of the comparator 719 (i.e., the control signal CN) has an H level in a time period in which the noise is larger than the reference voltage Va. The integration controller 614 outputs the control signal CN indicating the detection result of the unnecessary frequency component as a control signal GAJ, CN1, CN2, or CN3. The integration controller 614 may control output timing of the control signal GAJ, CN1, CN2, or CN3 so that the signal is output at appropriate timing.

When the control signal GAJ, CN1, CN2, or CN3 indicates that the unnecessary frequency component has been detected, the envelope generator 630 operates to mitigate an increase in the absolute value of the integral value obtained by the integrator 638. Specifically, when the unnecessary frequency component has been detected, the integration controller 614 outputs to the integrator 638, the control signal CN1 instructing to hold the integral value. The integrator 638 holds the integral value being output in accordance with the control signal CN1. The integration controller 614 allows the integrator 638 to hold the integral value until superimposition of the unnecessary frequency component is no longer detected.

When the unnecessary frequency component has been detected, the integration controller 614 may output to the data holder 642, the control signal CN2 instructing to hold a value in place of the control signal CN1. In this case, the data holder 642 holds the integral value output from the integrator 638 in accordance with the control signal CN2 and outputs the integral value to the selector 644. The selector 644 outputs the value held at the data holder 642 to the integrator 638. The integration controller 614 outputs to the integrator 638, the control signal CN1 for instructing to set the value input from the selector 644 as a new integral value. The integrator 638 sets the value input from the selector 644 as the new integral value.

A set value SV may be input to the selector 644, and then the value may be set to the integrator 638. Specifically, when the unnecessary frequency component has been detected, the integration controller 614 may output to the selector 644, the control signal CN3 instructing to select the set value SV in place of the control signal CN1. The selector 644 selects the set value SV and outputs the value to the integrator 638. The integration controller 614 outputs to the integrator 638, the control signal CN1 instructing to set a value input from the selector 644 as a new integral value. The integrator 638 sets the value input from the selector 644 as the new integral value. The set value SV is, for example, a value expected to stabilize the operation of the peak detection circuit 620. Note that a preferable set value SV may be input from the outside of the computing section 640.

When the unnecessary frequency component is no longer detected, the integration controller 614 outputs to the integrator 638, the control signal CN1 instructing to perform integration. The integrator 638 performs integration of an output of the selector 136 in accordance with the control signal CN1.

When the unnecessary frequency component has been detected, the integration controller 614 may output the control signal GAJ instructing to reduce the absolute value of the attack gain AGP. The attack gain generator 632 reduces the absolute value of the attack gain AGP in accordance with the control signal GAJ.

As such, according to the first variation, when an unnecessary frequency component is superimposed on the RF signal RI due to a scratch etc. on an optical disk, the integral value (the value of the peak signal PKE) is stable. This allows a feedback loop formed by the DAC 122, the comparator 124, the selector 136, and the integrator 638 of the peak detection circuit 620 to stably operate.

Note that, similar to the peak detection circuit 620 of FIG. 6, the bottom detection circuit 160 may include the integrator 638, the data holder 642, and the selector 644. The attack gain generator 172, the integrator 638, the data holder 642, and the selector 644 of the bottom detection circuit 160 may be controlled by the control signal GAJ, CN1, CN2, or CN3, similar to the peak detection circuit 620.

### Second Variation

FIG. 8 is a block diagram illustrating a configuration of a peak detection circuit 720 according to a second variation of the present disclosure. The peak detection circuit 720 of FIG. 8 differs from the peak detection circuit 120 of FIG. 1 in that it further includes a DA converted value regulator 746 and a low-pass filter (LPF) 748.

In the peak detection circuit 120 of FIG. 1, the DAC 122 may DA convert all bits of the integral value output from the integrator 138, or may DA convert predetermined higher bits of the integral value. For example, the DAC 122 may DA convert the higher bits except for the lower two bits of the integral value. This simplifies the circuit configuration of the DAC 122, thereby reducing power consumption and increasing the operational speed of the DAC 122.

However, in this case, accuracy of the DA conversion decreases. To address the problem, the DA converted value regulator 746 operates as follows. The DA converted value regulator 746 adds 1 to the lowest bit of the higher bits (i.e., the bits converted by the DAC 122) of the integral value output from the integrator 138 at a frequency corresponding to a number represented by the lower bits of the integral value which is not converted by the DAC 122 and outputs the sum to the DAC 122.

A specific example will be described where the bit number of the integral value output from the integrator 138 is 5, and the bit number of the input to the DAC 122 is 3. Assume that the integral value output from the integrator 138 is “00111.” When the lowest bit of the higher 3 bits converted by the DAC 122 is 1, the lower 2 bits “11” of the integral value is ¾. The DA converted value regulator 746 adds 1 to the lowest bit of the higher bits “001” of the integral value at the frequency of ¾ corresponding to the number represented by the lower 2 bits “11” of the integral value, and outputs the obtained value “010” to the DAC 122.

That is, when the integral value “00111” is input, the DA converted value regulator 746 sequentially outputs “001,” “010,” “010,” and “010.” The DAC 122 sequentially DA converts these values and outputs the obtained signal to the LPF 748. The LPF 748 smooths the signal converted by the DAC 122. The smoothed signal corresponds to a mean value of “001,” “010,” “010,” and “010.” The LPF 748 outputs the smoothed signal to the comparator 124. An analog signal output from the LPF 748 corresponds to the integral value “00111” of 5 bits. That is, the integral value can be converted to the analog signal without losing information of the integral value.

As such, according to the second variation, the accuracy of the analog signal output from the LPF 748 can be higher than the accuracy corresponding to the bit number which can be converted by the DAC 122.

Similar to the peak detection circuit 620 of FIG. 6, the bottom detection circuit 160 may include the DA converted value regulator 746 and the LPF 748.

While an example has been described where the peak detection circuit 120 etc. obtains the peak signal PKE, and the bottom detection circuit 160 obtains the bottom signal BTE; only the peak signal PKE may be obtained.

As described above, the embodiments of the present disclosure improve tracking characteristics of an envelope detected from an input signal to the input signal, and are thus useful for a detector, etc.

The many features and advantages of the present disclosure are apparent from the detailed specification and, thus, it is intended by the appended claims to cover all such features and advantages of the disclosure. Further, since numerous modifications and changes will readily occur to those skilled in the art, it is not desired to limit the disclosure to the exact construction and operation illustrated and described. Accordingly, all suitable modifications and equivalents may be resorted to, falling within the scope of the invention.

What is claimed is:

1. A detector configured to obtain an output signal from an input signal containing a target signal, and output the output signal, the detector comprising:
a comparator configured to compare the input signal to the output signal, and output an obtained comparison result; and
an envelope generator configured to weight a first value and a second value having a sign opposite to that of the first value in accordance with the comparison result, integrate the weighted first value and the weighted second value, and output an integral value as the output signal, wherein
the envelope generator includes a first gain generator configured to output the first value in accordance with an amplitude of the input signal.

2. The detector of claim 1, wherein
the first gain generator reduces an absolute value of the first value when the amplitude of the input signal is less than a threshold value.

3. The detector of claim 1, wherein
the envelope generator further includes a second gain generator configured to output the second value in accordance with the amplitude of the input signal.

4. The detector of claim 3, wherein
the second gain generator reduces an absolute value of the second value when the amplitude of the input signal is less than a threshold value.

5. The detector of claim 4, wherein
a ratio of the second value to the first value is constant.

6. The detector of claim 1, further comprising
a gain controller configured to generate a gain control signal corresponding to the amplitude of the input signal, wherein
the first gain generator outputs the first value in accordance with the gain control signal.

7. The detector of claim 6, wherein
the gain controller detects the amplitude of the input signal using the integral value.

8. The detector of claim 1, further comprising
a gain controller configured to determine whether or not a difference between the input signal and the integral value is equal to or greater than a predetermined reference value, and control the first gain generator to increase an absolute value of the first value when the gain controller has determined that the difference is equal to or greater than the predetermined reference value.

9. The detector of claim 1, further comprising
an integration controller configured to detect a unnecessary frequency component, which is a frequency component other than a frequency component of the target signal, from the input signal, and generate a control signal indicating a detection result, wherein
the envelope generator mitigates an increase in an absolute value of the integral value when the control signal indicates that the unnecessary frequency component is detected.

10. The detector of claim 9, wherein
the envelope generator further includes a computing section configured to obtain the integral value, and
the computing section holds the integral value when the control signal indicates that the unnecessary frequency component is detected.

11. The detector of claim 9, wherein
the envelope generator further includes a computing section configured to obtain the integral value, and
the computing section uses a set value as a new value of the integral value when the control signal indicates that the unnecessary frequency component is detected.

12. The detector of claim 9, wherein
the first gain generator reduces an absolute value of the first value when the control signal indicates that the unnecessary frequency component is detected.

13. The detector of claim 1, further comprising
a digital-to-analog (DA) converter performing DA conversion of a predetermined higher bit(s) of the integral value, wherein
the comparator compares the input signal to a signal converted by the DA converter.

14. The detector of claim 13, further comprising:
a DA converted value regulator configured to add 1 to the lowest bit of the predetermined higher bit(s) of the integral value, and output a sum to the DA converter at a frequency corresponding to a number represented by a lower bit(s) of the integral value which is/are not converted by the DA converter; and
a low-pass filter configured to smooth the signal converted by the DA converter, and output the smoothed signal to the comparator.

15. The detector of claim 1, wherein
the input signal is a radio frequency (RF) signal output from an optical pickup.

16. A detection method obtaining an output signal from an input signal containing a target signal, the method comprising:
comparing the input signal to the output signal;
weighting a first value and a second value having a sign opposite to that of the first value in accordance with an obtained comparison result, integrating the weighted first value and the weighted second value, and outputting an integral value as the output signal;
detecting from the input signal, an unnecessary frequency component which is a frequency component other than a frequency component of the target signal; and
mitigating an increase in an absolute value of the integral value when the unnecessary frequency component has been detected.

17. The method of claim 16, wherein
the integral value is held when the unnecessary frequency component has been detected.

18. The method of claim 16, wherein
a set value is used as a new value of the integral value when the unnecessary frequency component has been detected.

19. The method of claim 16, wherein
an absolute value of the first value is reduced when the unnecessary frequency component has been detected.
